(19) United States
(12) Patent Application Publication
(10) Pub. No.: US 2019/0174063 A1
(43) Pub. Date: Jun. 6, 2019

(54) Adaptive Image Processing in an Unmanned Autonomous Vehicle

(71) Applicant: QUALCOMM Incorporated, San Diego, CA (US)

(72) Inventors: Yin HUANG, Beijing (CN); Liang ZHANG, San Diego, CA (US); Xiaoyi ZHU, Beijing, CA (US); Ruowei WANG, Beijing (CN); Jiangato REN, Beijing (CN)

(21) Appl. No.: 16/324,351

(22) PCT Filed: Sep. 23, 2016
(86) PCT No.: PCT/CN2016/099885

§ 371 Date: Feb. 8, 2019

(51) Int. Cl. H04N 5/232; G06T 5/00; B64D 47/08; B64C 39/02

(52) U.S. Cl. CPC H04N 5/23267; G06T 5/006; B64C 2201/141; B64C 39/024; G06T 2207/20004; B64D 47/08

(57) ABSTRACT

Embodiments include devices and methods for adaptive image processing in an umnanned autonomous vehicle (UAV). In various embodiments, an image sensor may capture an image. Images may be obtained during motion or hover modes of the UAV. The UAV may determine whether stabilizing a line of the image causes a breach of an image crop margin. That is, the UAV may estimate or begin to adjust image distortion and crop the image, and may evaluate during or after the estimation/adjustment whether an image crop margin is breached by the result. The UAV may reduce stabilizing of the line of the image in response to determining that stabilizing the line of the image causes a breach of the image crop margin.

### BACKGROUND

Unmanned autonomous vehicles (UAVs) are being developed for a wide range of applications. UAVs are typically equipped with one or more sensors, such as cameras capable of capturing an image, a sequence of images, or video. However, motion of the UAV may cause an unacceptably distorted or wobbly image or video.

Image stabilization (IS) refers to the process of detecting and correcting spurious motion introduced due to camera shake during the capture of an image or video. In the most general sense, spurious global motion may include any deviation from and intended camera path and jitter introduced due to unintended camera movement.

A variety of mechanical image stabilization mechanisms and techniques are available. However, such mechanisms are typically too heavy and too expensive for incorporation into and use with most UAVs.

### SUMMARY

Various embodiments include methods that may be implemented on a processor of a UAV for processing an image captured by an image sensor of the UAV. Various embodiments may include an image sensor, such as a line-read (e.g., CMOS) camera of the UAV may capture an image. Images may be obtained during motion or hover modes of the UAV. A processor of the UAV may determine whether stabilizing a line of the image causes a breach of an image crop margin. That is, the UAV may estimate or begin to adjust image distortion and crop the image, and may evaluate during or after the estimation/adjustment whether an image crop margin is breached by the result. The UAV processor may reduce the stabilizing of the line of the image in response to determining that stabilizing the line of the image causes a breach of the image crop margin. Various embodiments include multiple procedures for adaptively backing off an image processing adjustment based, at least in part, on whether the result of the estimation/adjustment breaches the image crop margin.

Some embodiments include a UAV having an imaging sensor (e.g., a camera) and a processor configured with processor-executable instructions to perform operations of the methods summarized above. Some embodiments include a UAV having means for performing functions of the methods summarized above. Some embodiments include a processor-readable storage medium having stored thereon processor-executable instructions configured to cause a processor of a UAV to perform operations of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a UAV operating within communication system according to various embodiments.

FIG. 2 is a component block diagram illustrating components of a UAV according to various embodiments.

FIG. 3A is a component block diagram illustrating components of an image capture and processing system of a UAV according to various embodiments.

FIG. 3B illustrates a distorted image according to various embodiments.

FIG. 3C illustrates a corrected image according to various embodiments.

FIGS. 4A and 4B illustrate image distortion in an image captured by an image sensor on a moving platform according to various embodiments.

FIG. 5 illustrates a transformed image overlaid on a boundary region in an image processing scheme according to various embodiments.

FIG. 6 is a component block diagram illustrating transformation of lines of an image captured by a UAV according to various embodiments.

FIG. 7 is a process flow diagram illustrating methods for adaptive image processing according to various embodiments.

FIG. 8 is a process flow diagram illustrating methods for transforming an image captured by an image sensor of a UAV according to various embodiments.

FIG. 9 is a process flow diagram illustrating methods for transforming an image captured by an image sensor of a UAV according to various embodiments.

FIG. 10 is a process flow diagram illustrating methods for transforming an image captured by an image sensor of a UAV according to various embodiments.

FIG. 11 is a process flow diagram illustrating methods for error correcting during transformation of an image captured by an image sensor of a UAV according to various embodiments.

FIG. 12 is a process flow diagram illustrating embodiment methods for error correcting during transformation of an image captured by an image sensor of a UAV according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a UAV for processing an image captured by an image sensor of the UAV to adaptively crop images with the horizon and correct images for vehicle pitch and roll without the need for a physical gimbal. Various embodiments improve the efficiency and accuracy of image processing of such images captured using a rolling shutter type image sensor in a UAV subject to pitch, yaw, and roll. Various embodiments further improve efficiency and accuracy of image processing of images captured by a UAV in motion.

As used herein, the term “UAV” refers to one of various types of unmanned autonomous vehicles. A UAV may include an onboard computing device configured to maneuver and/or navigate the UAV without remote operating instructions (i.e., autonomously), such as from a human operator or remote computing device. Alternatively, the onboard computing device may be configured to maneuver and/or navigate the UAV with some remote operating instruction or updates to instructions stored in a memory of the onboard computing device. In some implementations, a UAV may be an aerial vehicle propelled for flight using a plurality of propulsion units, each including one or more rotors, that provide propulsion and/or lifting forces for the UAV. UAV propulsion units may be powered by one or more types of electric power sources, such as batteries, fuel cells, motor-generators, solar cells, or other sources of electric power, which may also power the onboard computing device, navigation components, and/or other onboard components.

UAVs are increasingly equipped with image sensor devices for capturing images and video. UAVs equipped to image the ground suffer from the problem that pitch and roll of the vehicle leads to images that are not aligned with the horizon. Further, spurious motions of the UAV may cause jitter or other distortions in images and video. While a variety of mechanical image stabilization mechanisms are available (e.g., mechanical gimbals and optical image stabilization (OIS)), such mechanisms are typically too heavy and too expensive for incorporation into and use with most UAVs.

Digital image stabilization (DIS) and electronic image stabilization (EIS) techniques may reduce or eliminate the need for mechanical image stabilization mechanisms, such as gimbals. A processor employing a DIS technique may estimate spurious motion of the UAV based on image data, such as changes from image to image, or frame to frame. For example, the processor may determine one or more image statistics from the image data. A processor may, for example, analyze consecutive frames to calculate a transform that when applied to an image or frame reduces the effects of motion with respect to the previous image or frame. However, image statistics cannot be used to easily distinguish motion of an image sensor from motion of a subject in an image sensor's field of view. Also, use of image statistics in image stabilization may result in additional jitter or shake in a video in particular when moving subjects are present in the image sensor's field of view. Additionally DIS performance may be impaired in conditions of low light or changing illumination.

To enable EIS, a processor of a UAV may analyze sensor data from a sensor of the UAV to determine spurious motion of the UAV. For example, a processor of the UAV may detect an orientation (e.g., pitch and roll) of the UAV, motion of the UAV (e.g., in three dimensions plus motion about the pitch, roll and yaw axes), accelerations (e.g., vibrations and jitter), and/or other information that may be available from one or more sensors (e.g., gyroscopes and accelerometers) of the UAV. Using the estimated orientation and motions of the UAV, the processor of the UAV may process an image or video to correct the image of distortions caused by the orientation and motions. In some embodiments, such processing may be performed in real time or in post-processing of the image or video. For example, a processor of the UAV may use sensor data to determine a rotation and translation to be applied to the output of the image sensor between two consecutive images or frames using, e.g., a gyroscope and accelerometer.

In an EIS system, the processor the UAV may process the image or video based on a coordinate system of the UAV, and information about the mounting of an image sensor on the UAV, as well as information about an orientation of the output of the image sensor.

For example, UAVs may include a wide variety of body frames, and manufacturers of such body frames may utilize different coordinate systems, for example, in a flight controller or another processor of the UAV. One example of a body frame coordinate system is North-East-Down (NED), in which positive values along the x-axis indicates north, positive values along the y-axis indicates east, and positive values along the x-axis indicates down (i.e., toward gravity). Another example of a body frame coordinate system is North-West-Up (NWU), in which positive values along the x-axis indicates north, positive values along the y-axis indicates west, and positive values along the x-axis indicates up (i.e., away from gravity). Different UAV manufacturers and suppliers may use different coordinate systems.

Various embodiments provide methods implemented by a processor of a UAV for processing an image captured by an image sensor of the UAV. Various embodiments further improve efficiency and accuracy of image processing of images captured by a UAV in motion, and further improve the efficiency and accuracy of image processing of such images subject to varying degrees of rolling shutter distortion caused by the pitch, yaw, and roll of an image sensor mounted to a UAV in motion.

In various embodiments, an image sensor, such as a line-read (e.g., CMOS) camera of the UAV may capture an image. Images may be obtained during motion or hover modes of the UAV. A processor of the UAV may determine whether stabilizing a line of the image causes a breach of an image crop margin. For example, the UAV may estimate or begin to adjust image distortion and crop the image, and may evaluate during or after the estimation/adjustment whether an image crop margin is breached by the result. The UAV processor may reduce the stabilizing of the line of the image in response to determining that stabilizing the line of the image causes a breach of the image crop margin. Various embodiments include multiple procedures for adaptively backing off an image processing adjustment based, at least in part, on whether the result of the estimation/adjustment breaches the image crop margin.

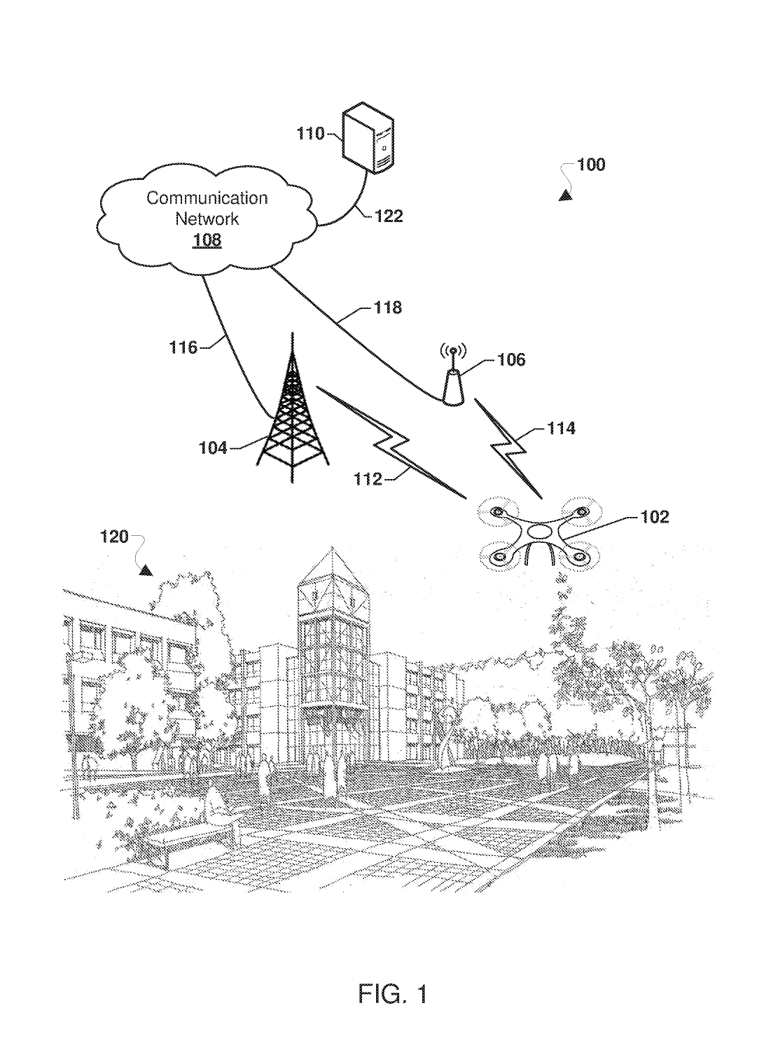

Various embodiments may be implemented within a UAV operating within a variety of communication systems 100, an example of which is illustrated in FIG. 1. With reference to FIG. 1, the communication system 100 may include a UAV 102, a base station 104, an access point 106, a communication network 108, and a network element 110.

The base station 104 and the access point 106 may provide wireless communications to access the communication network 108 over a wired and/or wireless communications backhaul 116 and 118, respectively. The base station 104 may include base stations configured to provide wireless communications over a wide area (e.g., macro cells), as well as small cells, which may include a micro cell, a femto cell, a pico cell, and other similar network access points. The access point 106 may include access points configured to provide wireless communications over a relatively smaller area. Other examples of base stations and access points are also possible.

The UAV 102 may communicate with the base station 104 over a wireless communication link 112, and with the access point 106 over a wireless communication link 114. The wireless communication links 112 and 114 may include a plurality of carrier signals, frequencies, or frequency bands, each of which may include a plurality of logical channels. The wireless communication links 112 and 114 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

The network element 110 may include a network server or another similar network element. The network element 110 may communicate with the communication network 108 over a communication link 122. The UAV 102 and the network element 110 may communicate via the communication network 108. The network element 110 may provide the UAV 102 with a variety of information, such as navigation information, weather information, information about local air, ground, and/or sea traffic, movement control instructions, and other information, instructions, or commands relevant to operations of the UAV 102.

In various embodiments, the UAV 102 may move through an environment 120. As the UAV 102 moves through the environment 120, the processor of the UAV 102 may capture images or video of an aspect of the environment 120.

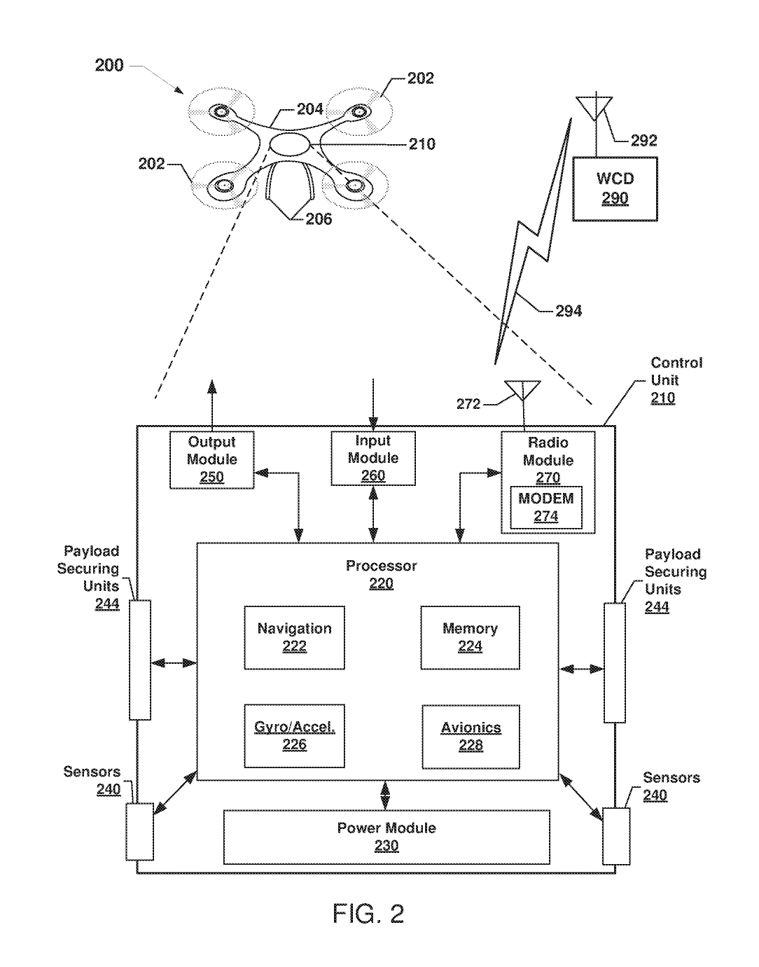

UAVs may include winged or rotorcraft varieties. FIG. 2 illustrates an example UAV 200 of a rotary propulsion design that utilizes one or more rotors 202 driven by corresponding motors to provide lift-off (or take-off) as well as other aerial movements (e.g., forward progression, ascension, descending, lateral movements, tilting, rotating, etc.). The UAV 200 is illustrated as an example of a UAV that may utilize various embodiments, but is not intended to imply or require that various embodiments are limited to rotorcraft UAVs. Various embodiments may be used with winged UAVs as well. Further, various embodiments may equally be used with land-based autonomous vehicles, water-borne autonomous vehicles, and space-based autonomous vehicles.

With reference to FIGS. 1 and 2, the UAV 200 may be similar to the UAV 102. The UAV 200 may include a number of rotors 202, a frame 204, and landing columns 206 or skids. The frame 204 may provide structural support for the motors associated with the rotors 202. The landing columns 206 may support the maximum load weight for the combination of the components of the UAV 200 and, in some cases, a payload. For ease of description and illustration, some detailed aspects of the UAV 200 are omitted such as wiring, frame structure interconnects, or other features that would be known to one of skill in the art. For example, while the UAV 200 is shown and described as having a frame 204 having a number of support members or frame structures, the UAV 200 may be constructed using a molded frame in which support is obtained through the molded structure. While the illustrated UAV 200 has four rotors 202, this is merely exemplary and various embodiments may include more or fewer than four rotors 202.

The UAV 200 may further include a control unit 210 that may house various circuits and devices used to power and control the operation of the UAV 200. The control unit 210 may include a processor 220, a power module 230, sensors 240, payload-securing units 244, an output module 250, an input module 260, and a radio module 270.

The processor 220 may be configured with processor-executable instructions to control travel and other operations of the UAV 200, including operations of various embodiments. The processor 220 may include or be coupled to a navigation unit 222, a memory 224, a gyro/accelerometer unit 226, and an avionics module 228. The processor 220 and/or the navigation unit 222 may be configured to communicate with a server through a wireless connection (e.g., a cellular data network) to receive data useful in navigation, provide real-time position reports, and assess data.

The avionics module 228 may be coupled to the processor 220 and/or the navigation unit 222, and may be configured to provide travel control-related information such as altitude, attitude, airspeed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, or other similar sensors. The avionics module 228 may include or receive data from the gyro/accelerometer unit 226 that provides data regarding the orientation and accelerations of the UAV 200 that may be used in navigation and positioning calculations, as well as providing data used in various embodiments for processing images.

The processor 220 may further receive additional information from the sensors 240, such as an image sensor or optical sensor (e.g., capable of sensing visible light, infrared, ultraviolet, and/or other wavelengths of light). The sensors 240 may also include a radio frequency (RF) sensor, a barometer, a sonar emitter/detector, a radar emitter/detector, a microphone or another acoustic sensor, or another sensor that may provide information usable by the processor 220 for movement operations as well as navigation and positioning calculations. The sensors 240 may include contact or pressure sensors that may provide a signal that indicates when the UAV 200 has made contact with a surface. The payload-securing units 244 may include an actuator motor that drives a gripping and release mechanism and related controls that are responsive to the control unit 210 to grip and release a payload in response to commands from the control unit 210.

The power module 230 may include one or more batteries that may provide power to various components, including the processor 220, the sensors 240, the payload-securing units 244, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The UAV 200 may be controlled through control of the individual motors of the rotors 202 as the UAV 200 progresses toward a destination. The processor 220 may receive data from the navigation unit 222 and use such data in order to determine the present position and orientation of the UAV 200, as well as the appropriate course towards the destination or intermediate sites. In various embodiments, the navigation unit 222 may include a GNSS receiver system (e.g., one or more global positioning system (GPS) receivers) enabling the UAV 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other UAVs, etc.

The radio module 270 may be configured to receive navigation signals, such as signals from aviation navigation facilities, etc., and provide such signals to the processor 220 and/or the navigation unit 222 to assist in UAV navigation. In various embodiments, the navigation unit 222 may use signals received from recognizable RF emitters (e.g., AM/FM radio stations, Wi-Fi access points, and cellular network base stations) on the ground.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smartphone, a tablet, or another computing device with which the UAV 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a UAV operator, a third party service (e.g., package delivery, billing, etc.), or a site communication access point. The UAV 200 may communicate with a server through one or more intermediate communication links, such as a wireless telephony network that is coupled to a wide area network (e.g., the Internet) or other communication devices. In some embodiments, the UAV 200 may include and employ other forms of radio communication, such as mesh connections with other UAVs or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera or sensor, or may receive electronic signals from other components (e.g., a payload).

While various components of the control unit 210 are illustrated as separate components, some or all of the components (e.g., the processor 220, the output module 250, the radio module 270, and other units) may be integrated together in a single device or module, such as a system-on-chip module.

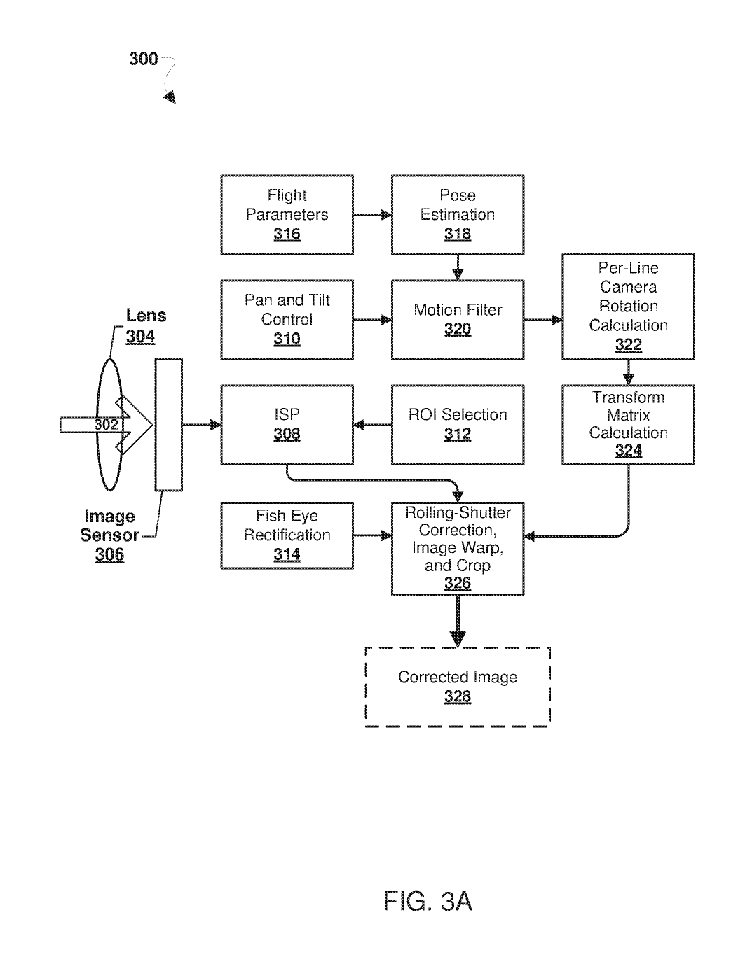

FIG. 3A illustrates an image capture and processing system 300 of a UAV (e.g., 102, 200 in FIGS. 1 and 2) according to various embodiments. With reference to FIGS. 1-3A, the image capture and processing system 300 may be implemented in hardware components and/or software components of the UAV, the operation of which may be controlled by one or more processors (e.g., the processor 220 and/or the like) of the UAV. To enable digital image stabilization, spurious motion of the UAV may be estimated from information detected by a processor of the UAV. One embodiment of components that may enable such digital image stabilization is illustrated in the image capture and processing system 300.

An image sensor 306 may capture light of an image 302 that enters through a lens 304. The lens 304 may include a fish eye lens or another similar lens that may be configured to provide a wide image capture angle. The image sensor 306 may provide image data to an image signal processing (ISP) unit 308. A region of interest (ROI) selection unit 312 may provide data to the ISP 308 data for the selection of a region of interest within the image data.

The ISP 308 may provide image information and ROI selection information to a rolling-shutter correction, image warp, and crop unit 326. A fish eye rectification unit 314 may provide information and/or processing functions to the rolling-shutter correction, image warp, and crop unit 326.

A flight parameters unit 316 may determine inertial measurement data and UAV position and orientation data. For example, the flight parameters unit 316 may obtain or receive the inertial measurement data and UAV position and orientation data from one or more sensors of the UAV (e.g., the sensors 240). The flight parameters unit 316 may provide the inertial measurement data and UAV position and orientation data to a pose estimation unit 318. (“Pose” is a portmanteau of “position” and “orientation.”)

The pose estimation unit 318 may determine a position and orientation of the UAV based on the inertial measure data and the position and orientation data. In some embodiments, the pose estimation unit 318 may determine the position and orientation (e.g., pitch, roll, and yaw) of the UAV based on a coordinate system of the UAV (e.g., NED or NWU). The pose estimate unit 318 may provide the determined position and orientation of the UAV to a motion filter unit 320. Additionally, a pan and tilt control unit 310 may provide data about the pan and/or tilt of the image sensor to the motion filter unit 320.

The motion filter unit 320 may determine physical and/or virtual pose changes of an image sensor of the UAV (e.g., a sensor 240) based on the position and orientation information from the pose estimation unit 318 and the pan and/or tilt information from the pan and tilt control unit 310. In some embodiments, the motion filter unit 320 may determine the physical or virtual pose changes of the image sensor over time. In some embodiments, the motion filter unit 320 may determine the physical or virtual pose changes based on one or more changes between a first image and second subsequent image. In some embodiments, the motion filter unit 320 may determine the physical or virtual pose changes of the image sensor on a frame-by-frame basis. The motion filter unit may provide the determined physical and/or virtual pose changes of an image sensor to a per-line camera rotation calculation unit 322.

The per-line camera rotation calculation unit 322 may determine a rotation to perform to the image information on a line-by-line basis. The per-line camera rotation calculation unit 322 may provide information about the determined rotation to a transform matrix calculation unit 324.

The transform matrix calculation unit 324 may determine a transformation matrix for use in processing an image. The transform matrix calculation unit 324 may provide the transformation matrix to the rolling-shutter correction and warp unit 326.

The rolling-shutter correction and warp unit 326 may crop the image information, correct for distortions in the image caused by the lens 304, and may apply the transformation matrix to the image information. The rolling-shutter correction and warp unit 326 may provide as output a corrected image 328 based on the cropping, distortion correction, and/or application of the transformation matrix. In some embodiments, the corrected image may include an image having a corrected horizontal orientation or horizontal rotation. In some embodiments, the corrected image may include a stabilized video output.

FIG. 3B illustrates a distorted image 350 according to various embodiments. With reference to FIGS. 1-3B, the distorted image 350 may include one or more distortions, for example a curvature of a straight object 352, or the distortions indicated by distortion markers 354 and 356, and by the test image 358.

FIG. 3C illustrates a corrected image 328 according to various embodiments. With reference to FIGS. 1-3C, the corrected image 328 has been rotated 90 degrees counterclockwise, and includes corrections to, for example, the straight object 352 and the test image 358.

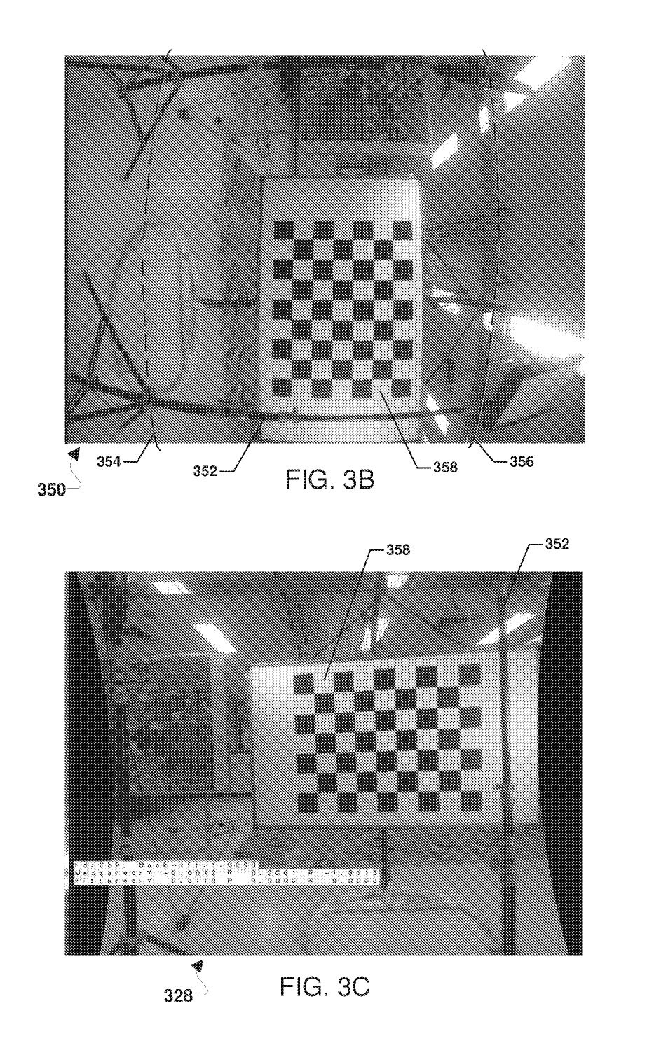

FIGS. 4A and 4B illustrate image distortion in an image captured by an image sensor on a moving platform according to various embodiments. With reference to FIGS. 1-4B, a processor of a UAV (e.g., the processor 220 and/or the like) and hardware components and/or software components of the UAV may capture and process an image or video using an image sensor of the UAV (e.g., the sensor 240).

FIG. 4A illustrates an image 402 captured by a moving image sensor, which includes a skewed object 404. For example, rolling shutter distortion may occur in images, and particularly video, captured by certain image sensors (e.g., complementary metal-oxide-semiconductor (CMOS) image sensors), which record every frame line-by-line from top to bottom of the image, rather than as a single snapshot at a point in time. Because parts of the image are captured at different times, image sensor motion may cause image distortion referred to as a “jelly-effect” or “Jello wobble.” The distortion illustrated in the image 402 may be caused by an object moving quickly through the image sensor's field of view, or by camera translation (e.g., horizontal or rotational motion of the camera). In addition, fast-moving objects may be distorted with diagonal skews, as illustrated by a skewed object 404 in the image 402. A processor may determine motion of the images sensor during the time taken to traverse from the first to the last line of the frame, and the processor may correct for sensor-motion induced rolling shutter distortion.

FIG. 4B illustrates rolling shutter distortion that may be cause by a pitch and a yaw of a motion sensor. Image sensor rotation (e.g., caused by pitch and yaw of a platform of the image sensor, e.g., a UAV) may cause two distinct effects due to the rolling shutter. For example, changes in yaw during exposure of a frame may cause vertical lines to develop a diagonal skew 406. In addition, changes in pitch during exposure of a frame may change a separation 408 between horizontal lines and may lead to a perception of residual motion along a Y-axis (e.g., horizontal axis) of the image.

In some embodiments, a processor may correct rolling shutter distortion by modeling a motion of pixels within the image or frame. For example, the processor may divide the image or frame into multiple sub-frames and calculate an affine transform for each sub-frame. In some implementations, the processor may model the motion of pixels captured at times t1-t6 as compared to time tf. Time tf may include a selected reference time, which may be a midpoint time between times t1 and t6. In some embodiments, time t1 may equal the start time of frame capture (SOF) minus half of an exposure duration (a duration of time during which the image or frame is captured), and may be represented according to the following equation:

t1=SOF−exposure/2 [Equation 1]

In some embodiments, t6 may equal the end time of frame capture (EOF) minus half of the exposure duration, and may be represented according to the following equation:

t6=EOF−exposure/2 [Equation 2]

In some embodiments, tf may be represented according to the following equation:

tf=(t1+t6)/2 [Equation 3]

In some embodiments, the processor may determine the number of sub-frames (e.g., sub-frames at times t1, t2, t3, t4, t5, and t6) as a function of a maximum frequency of motion (which may be set as an image capture parameter).

The processor may then determine a transform, such as an affine transform, for time tf. The processor may apply the determined transform 410 to each sub-frame. Applying the transform to each sub-frame serves to model the entire frame as being captured by a global shutter at time tf.

UAVs, and relatively smaller UAVs in particular, may experience rotor spinning with high revolutions per minute (RPM) (e.g., 10× thousands RPM) that may cause the UAV to shake or wobble. As such, a rolling shutter image sensor may capture images subject to significant distortion. Correcting such inhomogeneous motion per frame may include dividing an entire image, or an entire frame of a video, into multiple stripes, in which each stripe may be a row or multiple rows. Each row may be based on the image sensor line read input, or may be a division of the entire image (or frame) into stripes of a determined height and width, or a division of the entire image (or frame) into a determined number of stripes regardless of height and width. The correction may also include estimating an image sensor pose per stripe (e.g., based on an interpolation between two determined positions). Finally, the correction may include applying the per stripe pose (e.g., transformation matrix) to correct distortion in the image (or frame).

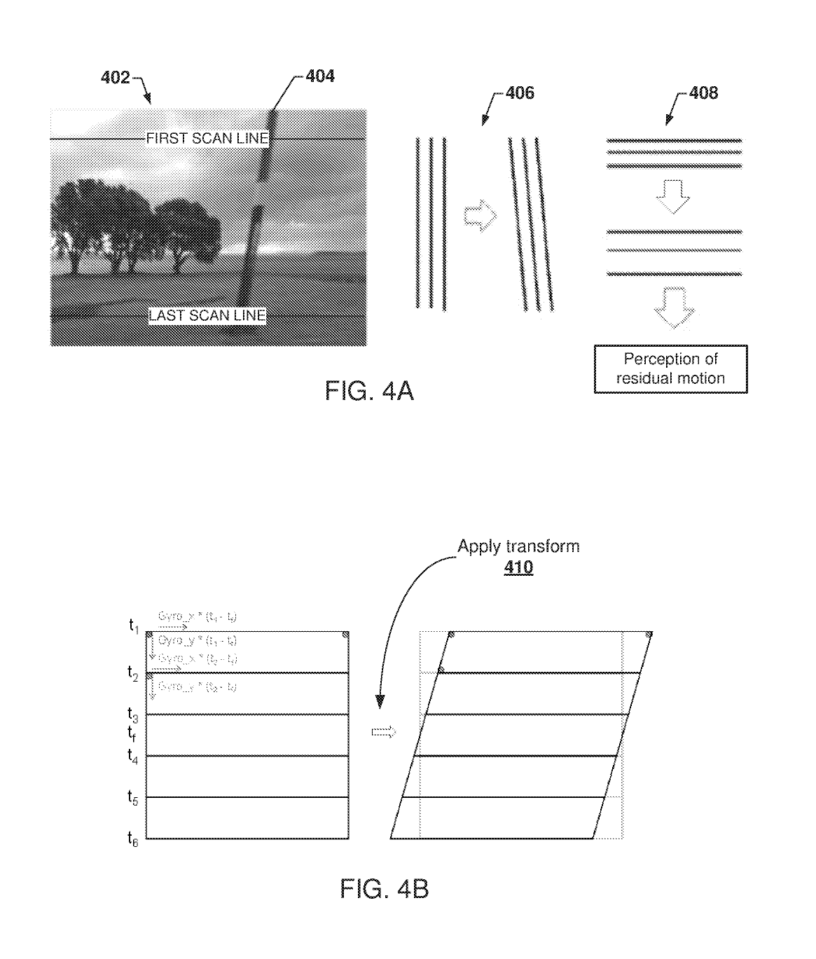

FIG. 5 illustrates image processing 500 in UAV according to various embodiments. With reference to FIGS. 1-5, a processor of a UAV (e.g., the processor 220 and/or the like) and hardware components and/or software components of the UAV may capture and process an image or video using an image sensor of the UAV (e.g., the sensor 240).

An image captured by the image sensor of a UAV may have a generally uniform geometric boundary 504. However, the subject of such images may be visually skewed and require adjustment or transformation in order to correct the visual depiction. The transformed image may have an irregularly shaped boundary 502. Both the captured image and the transformed images are likely to be larger than the threshold boundary 506 the UAV processor employs for image processing. Thus, only those portions of the captured and/or transformed image that lie within the image crop margin 508 defined by the threshold boundary 506 will be output for display, storage, or further image processing.

Margins limit how much shake/jitter can be removed from a video or image captured by the UAV. If the margin is very small, EIS may not be able to accurately and efficiently remove shake/jitter resulting from margin breaches. Margin breaches occur when a portion of the captured or transformed image boundaries 504, 502, cross over the image crop margin 508. The margin may include two parts: a physical margin and a virtual margin. The physical margin may be provided by the image sensor and may not affect video or image quality. But, the virtual margin may include an extra margin or buffer zone and may result in image blur.

When EIS is enabled, the processor of the UAV may allocate a buffer that is larger than the desired output image. The captured image contains actual image pixel data, some of which may be cropped during image processing. As the image sensor moves along with the UAV, the image sensor may shake and the field of view (FOV) captured within a desired output boundary may move. As long as the shake is low to moderate, the processor may move the captured image boundary 504 within the output boundary counter to the direction of motion to provide a stable image. However, if the shake/jitter is large enough, the need to move the captured image boundary 504 to counter the motion exceeds the perimeter of the output boundary. This is called a margin breach. Parts of the captured image 504 that lie outside the boundary cannot be filled with valid pixel data as the valid pixels lie within the output boundary. Thus, when a margin breach occurs, a correction cannot be made and a visual jump may be observed in the captured video or white/empty space in an image.

Typical pre-set physical margins may be 10% of the image size. This provides a 5%“half” margin on all four sides of the image. A 5% “half” margin may be insufficient to stabilize video or images in situations involving rapid movement or heavy pitch, yaw, or roll of the UAV. Virtual margin may be introduced to provide additional buffer and enable more accurate and efficient stabilization in UAVs, which may move at high speeds and with substantial shake/jitter while in flight. Working within the virtual instead of the physical margin when countering motion may place some parts the captured image 504 outside the output boundary, the processor may not report a margin breach and may continue image processing and image distortion correction. But because there is no valid pixels for parts of the output image that crosses the physical margin, artifacts may appear in these areas. To prevent the artifacts from appearing in an output image, a crop may be applied.

The image crop margin 508 may be smaller than the captured image 504 and thus may require that the image be zoomed to the output resolution (e.g., 1080P) and in doing some blur may be introduced.

In various embodiments, the physical margin on each side of the image P (usually 5%) and the virtual margin on each side V (usually from 2.5%-5%) may be used to represent the margin and crop scale. For example, the margin and crop scale may be represented by the functions:

$$\begin{matrix}{Margin}_{scale} = \frac{P + V}{P} & [ Equation 4 ] \\ {Crop}_{scale} = 1 + 2 V & [ Equation 5 ]\end{matrix}$$

As part of a pan filtering, the UAV processor may determine when a transformed image boundary 502 approaches the edges of the image crop margin 508. Four points represented by the four corners of the image, in_points=(1, 1), (w, 1), (1, h), (w, h) may be tracked with reference to an estimated transformation of the image (out_points). The parameters w and h refer to the width and height of the image frame. The maximum shift among these four points along both the x and y axes may be represented by the functions:

Xshift=max(abs(out_points(:,1)−in_points(:,1))) [Equation 6]

Yshift=max(abs(out_points(:,2)−in_points(:,2))) [Equation 7]

This xshift and yshift may be used to constraint the projective transform and set panning filter parameters. It may be difficult to calculate what projective transform (e.g., transformed image boundary 502) can be applied to the captured image 504 such that corner points will map to the edges of the allowed image crop margin 508. Instead, this may be inferred by calculating the position of the corners of the transformed image boundary 502 from the captured image 504 and checking whether the corners are within the margin. If this is true, the transformed image will not intersect the image crop margin 508.

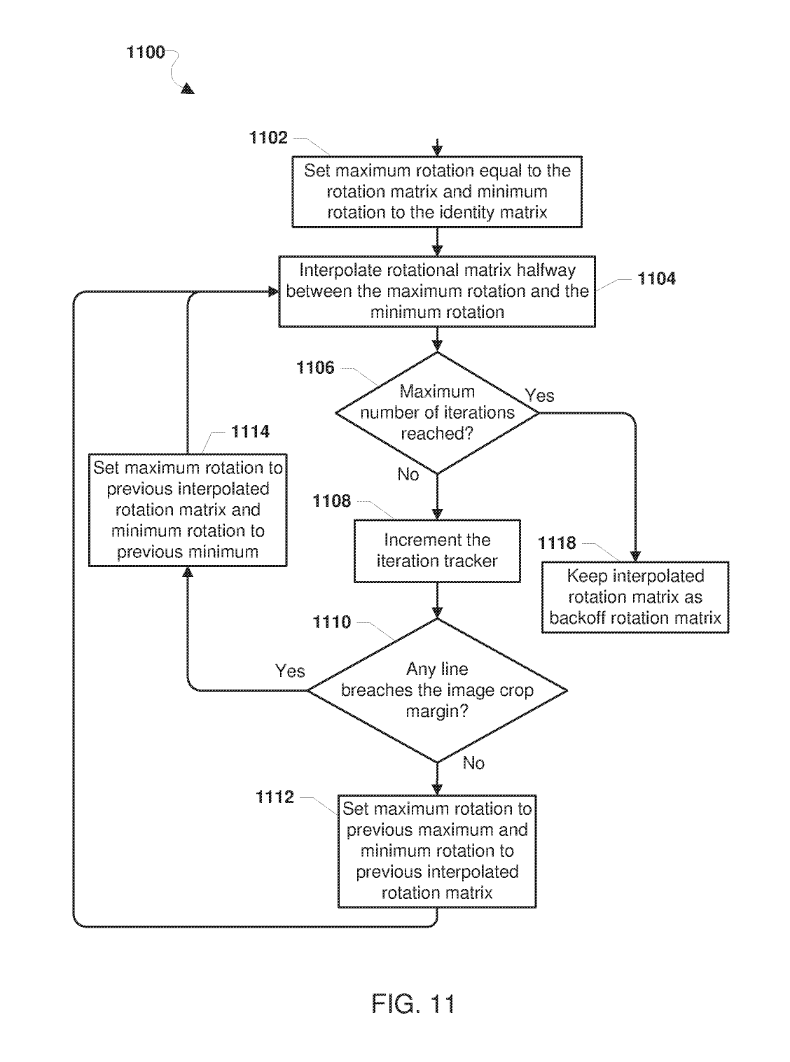

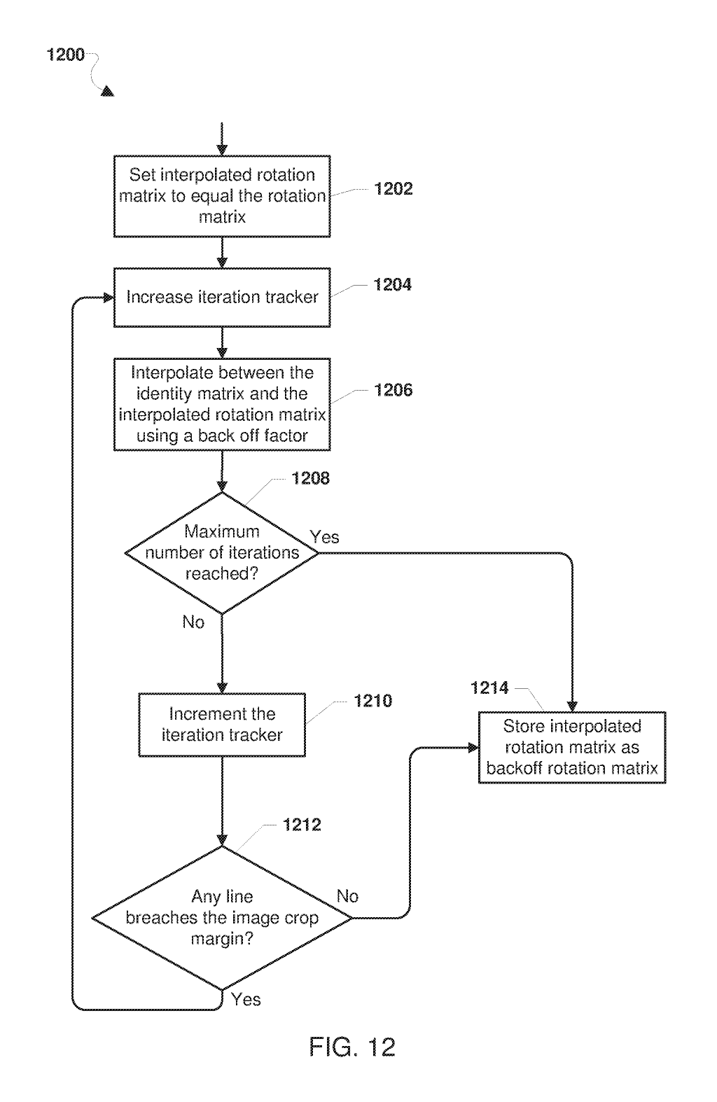

Various embodiments may employ an iterative strategy to adjust an image transformation to remove image crop margin breach. As is discussed in greater detail with reference to FIGS. 11 and 12, the processor may interpolate a transformation between two rotation extremes. The transformation matrix TF may be represented by a matrix multiplication of the image sensor capture K and a rotation R_{c} such that:

TF=KR_{c}K⁻¹ [Equation 8]

The image sensor capture may be mapped to the matrix K. A point (X, Y, Z) in 3D space may be mapped to an image plane (x, y) based on pin-hole. The image sensor capture may be represented as:

$$K = [ \begin{matrix}F * zoom & 0 & {c}_{x} \\ 0 & F * zoom & {c}_{y} \\ 0 & 0 & 1\end{matrix} ] \qquad [ Equation 9 ]$$

Where F is a focal length in unit of pixels which relates to the image resolution, lens focal length and camera sensor size.

The transformation may be interpolated between a maximum rotation, such as the UAV's rotation as calculated from motion detectors such as a gyroscope, and an identity matrix indicating no rotation. A static step size such as 0.5 may be used, thus halving the range of rotation with each iteration. For example, the first range of rotation may be multiplied by 0.5 and the reduced range of rotation may be used as the second pass for correction of the transformation matrix. This may have the effect that only half the contribution of the shake in the current frame is taken into account. After this, the new positions of in_points are calculated for the new projective transform and margin_breach are calculated again. Because multiple subframes may be used for rolling shutter correction, the processor may check for margin breach at the corners of each sub-frame in addition to or in lieu of checking for margin breach by the image transformation.

Performing an image warp process may require a processor to perform a pixel-by-pixel read/write operation, which may be processor-intensive and may require both high processing throughput and high bandwidth throughput. Performing the composite or one step operation reduces processing demands on the processor and other processing resources, as well as reducing consumption of a battery or other power resources.

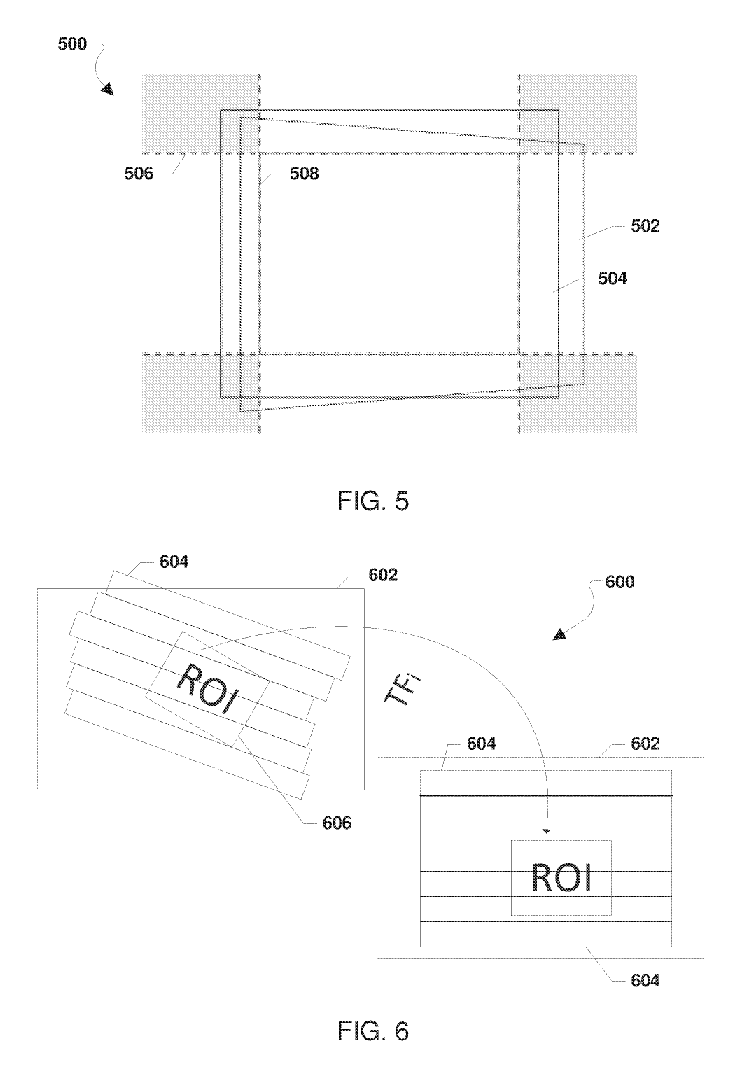

FIG. 6 illustrates image processing 600 in UAV according to various embodiments. With reference to FIGS. 1-6, a processor of a UAV (e.g., the processor 220 and/or the like) and hardware components and/or software components of the UAV may capture and process an image or video using an image sensor of the UAV (e.g., the sensor 240).

An image divided into subframes as a result of a line-read image sensor capture may have multiple subframes 604 that are skewed with reference to the horizontal/level image 602. A region of interest 606 within the captured image may be skewed as a result of the rolling shutter distortion and or pitch, yaw, roll of the UAV. By applying a transformation matrix to subframes 604, the subframes may be corrected to provide an even horizontal image in which the region of interest 606 appears horizontal.

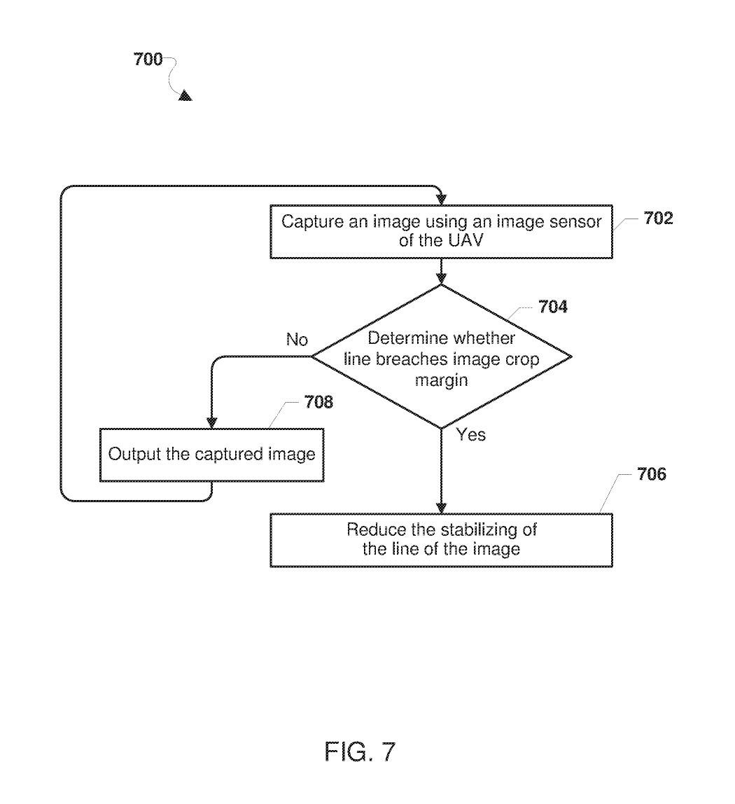

FIG. 7 illustrates a method 700 of adaptive image processing in a UAV (e.g., 102, 200 in FIGS. 1 and 2) according to various embodiments. With reference to FIGS. 1-7, the method 700 may be implemented by a processor (e.g., the processor 220 and/or the like) of the UAV.

In block 702, the image sensor may capture an image (e.g., using an image sensor of the UAV). For example, an image sensor mounted on or integrated into a UAV may capture an image or frame of a video. In some embodiments, the image sensor may include rolling shutter type image sensors that capture images and video line-by-line.

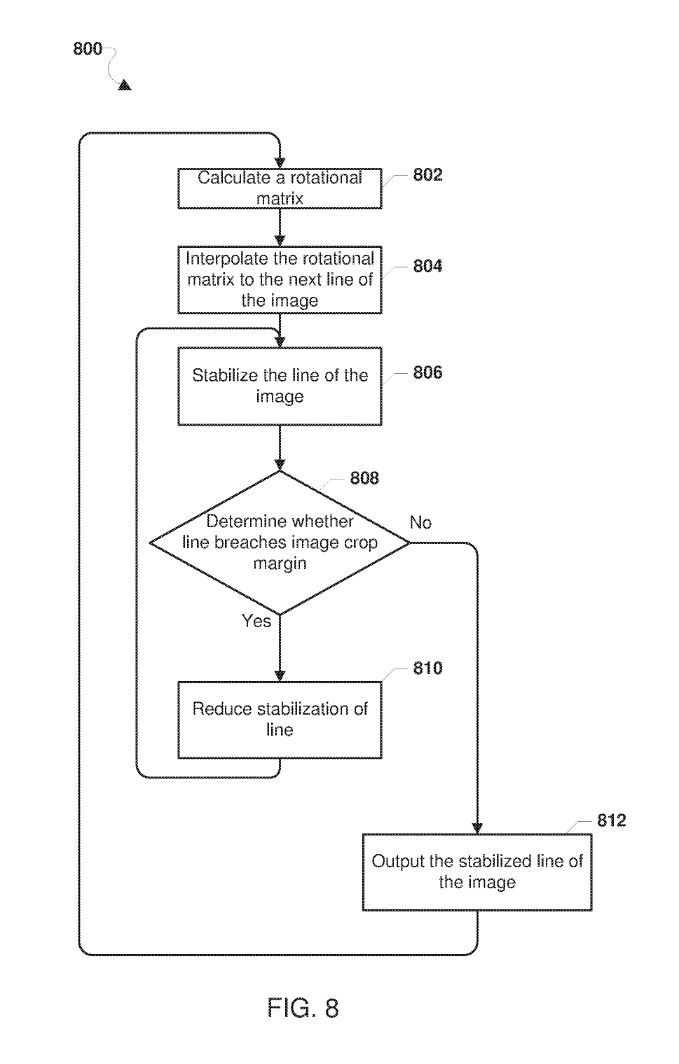

In determination block 704, the processor may determine whether stabilizing a line of the image causes a breach of an image crop margin. The processor may estimate the transformation of one or more lines/subframes of the captured image. That is, the processor may perform error correction in order to mitigate rolling shutter distortion due to the pitch, yaw, and roll of the UAV during motion or hovering operations. The processor may analyze the estimated or adjusted transformation in order to determine if any boundary of the transformed image 502 crosses within an image crop margin 508. As is discussed in greater detail with reference to FIGS. 8-10, the processor may estimate the transformation first prior to making any image adjustments or may make adjustments and evaluate margin breach as each adjustment is made.

In response to determining that stabilizing the line of the image causes a breach of the image crop margin (i.e., determination block 704=“Yes”) the processor may, in block 706, reduce the stabilizing of the line of the image. The processor may determine that transforming the captured image has or will result in a margin breach by at least one line/subframe of the image. If a margin breach has occurred or is likely to occur if the transformation matrix is applied, then the processor may implement a back off procedure to customize the transformation matrix. In various embodiments, an interpolated rotation matrix may be applied to each subframe. In various embodiments, the entire image may be subjected to a single interpolated rotation matrix. This interpolated rotation matrix may be referred to as a back off transformation matrix.

In response to determining that stabilizing the line of the image does not cause a breach of the image crop margin (i.e., determination block 704=“No”) the processor may, in block 708, output the image. If no margin breach is detected in the estimated transformation or the actual adjustment, then the processor may continue with further image processing and may display, store, or otherwise output the image.

FIG. 8 illustrates a method 800 of stabilizing an image captured in a UAV (e.g., 102, 200 in FIGS. 1 and 2) according to various embodiments. With reference to FIGS. 1-8, the method 800 may be implemented by a processor (e.g., the processor 220 and/or the like) of the UAV.

In block 802, the processor may calculate a rotation matrix defining the rotation of the image sensor of the UAV. The rotation matrix R_{c} may represent the movement in 3D space of the UAV and consequently, the image sensor. The rotation matrix may be a 3×3 matrix indicating a positive or negative movement in each axial or spherical direction. The rotation matrix may provide a baseline rotation indicating the scope of the entire image's rotation irrespective of any rolling shutter distortion. Thus, the rotation matrix may be generally applied to captured images to correct general image distortion. However, the effects of rolling shutter distortion may shift lines/subframes of the image as shown in FIG. 4B, and thus the rotation matrix may represent more rotation than is effectively represented in the image, because rolling shutter distortion may inadvertently compensate for some UAV rotation.

In some embodiments, the rotation matrix may be calculated every 2 ms and may be filtered to accommodate panning of hovering UAVs.

In block 804, the processor may interpolate the rotation matrix to a line of the image to obtain a line rotation matrix. Starting with the first line read in by the image sensor, the processor may step iteratively through each subframe of the captured image and may interpolate an appropriate transformation matrix for the subframe. Using the position of a subframe (e.g., the four corners), the processor may interpolate the rotation of the subframe with reference to rotation of the image sensor/UAV and may calculate an interpolated rotation matrix for the subframe.

In block 806, the processor may stabilize the line of the image based, at least in part, on the line rotation matrix and a camera matrix. The processor may use the interpolated rotation matrix along with the image sensor capture matrix shown in equation 9 to determine the transformation matrix as in equation 8. The processor may apply this transformation matrix TF to the respective line/subframe in order to correct the image distortion of the individual line/subframe.

In determination block 808, the processor may determine whether stabilizing a line of the image causes a breach of an image crop margin. As discussed with reference to block 704, of FIG. 7, the processor may determine whether the adjusted line/subframe breaches the image crop margin 508, by comparing the position of the transformed line/subframe with the boundaries of the image crop margin 508. In this manner, the processor may detect whether stabilizing the line/subframe has caused a breach of the image crop margin.

In response to determining that stabilizing the line of the image causes a breach of the image crop margin (i.e., determination block 808=“Yes”) the processor may, in block 810, reduce the stabilizing of the line of the image. This may be accomplished in the manner described with reference to block 706 of FIG. 7, and FIGS. 11 and 12.

In response to determining that stabilizing the line of the image does not cause a breach of the image crop margin (i.e., determination block 808 “No”) the processor may, in block 812, output the line of the image. This may be accomplished in the manner described with reference to block 708 of FIG. 7.

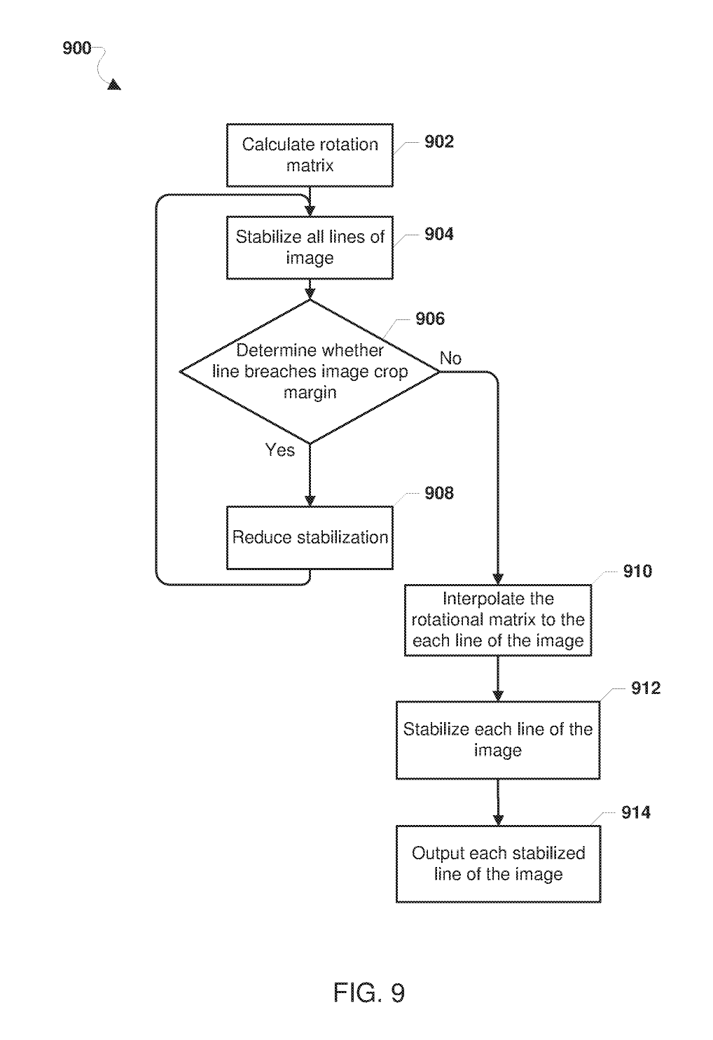

FIG. 9 illustrates a method 900 of stabilizing an image captured in a UAV (e.g., 102, 200 in FIGS. 1 and 2) according to various embodiments. With reference to FIGS. 1-9, the method 900 may be implemented by a processor (e.g., the processor 220 and/or the like) of the UAV.

In block 902, the processor may calculate a rotation matrix defining the rotation of the image sensor of the UAV. This may be accomplished in the manner described with reference to block 802 of FIG. 8.

In block 904, the processor may stabilize the image based, at least in part, on the rotation matrix and a camera matrix. The processor may apply the general image sensor capture matrix and rotation matrix to equation 8 in order to obtain the transformation matrix TF. As indicated previously, the general camera rotation matrix may provide a numerical representation of how the UAV/image sensor rotation and thus the overall image rotation.

In determination block 906, the processor may determine whether stabilizing a line of the image causes a breach of an image crop margin, by determining whether any line of the stabilized image causes a breach of the image crop margin. The processor may estimate the transformation of the entire image, rather than each line individually. This estimated transformation may be compared to the image crop margin 508 to determine if any part of the estimated transformation breaches the margin. For example, transformation boundary 501 in FIG. 5 shows a potential transformation of the captured image 504 and does not cross over the image crop margin 508.

In response to determining that stabilizing the line of the image causes a breach of the image crop margin (i.e., determination block 906=“Yes”) the processor may, in block 908 reduce stabilizing the line. This may be accomplished in the manner described with reference to block 706 of FIG. 7 as well as FIGS. 11 and 12.

In response to determining that stabilizing the line of the image does not cause a breach of the image crop margin (i.e., determination block 906=“No”) the processor may, in block 910 interpolate the rotation matrix to each line of the image to obtain a line rotation matrix for each respective line. As described in block 804 of FIG. 8, the processor may calculate a rotation matrix and subsequently a transformation matrix for each subframe. By first evaluating whether any part of the estimated transformation would cause a margin breach, the processor can evaluate whether it is safe to proceed with a line by line transformation. Thus, the processor may waste less time and processing power individually transforming subframes.

In block 912, the processor may stabilize each line of the image based, at least in part, on the line rotation matrix for each respective line and a camera matrix. That is, the processor may apply the line/subframe specific transformation matrix to each subframe.

In block 914, the processor may output each stabilized line of the image. This may be accomplished in the manner described with reference to block 708 of FIG. 7.

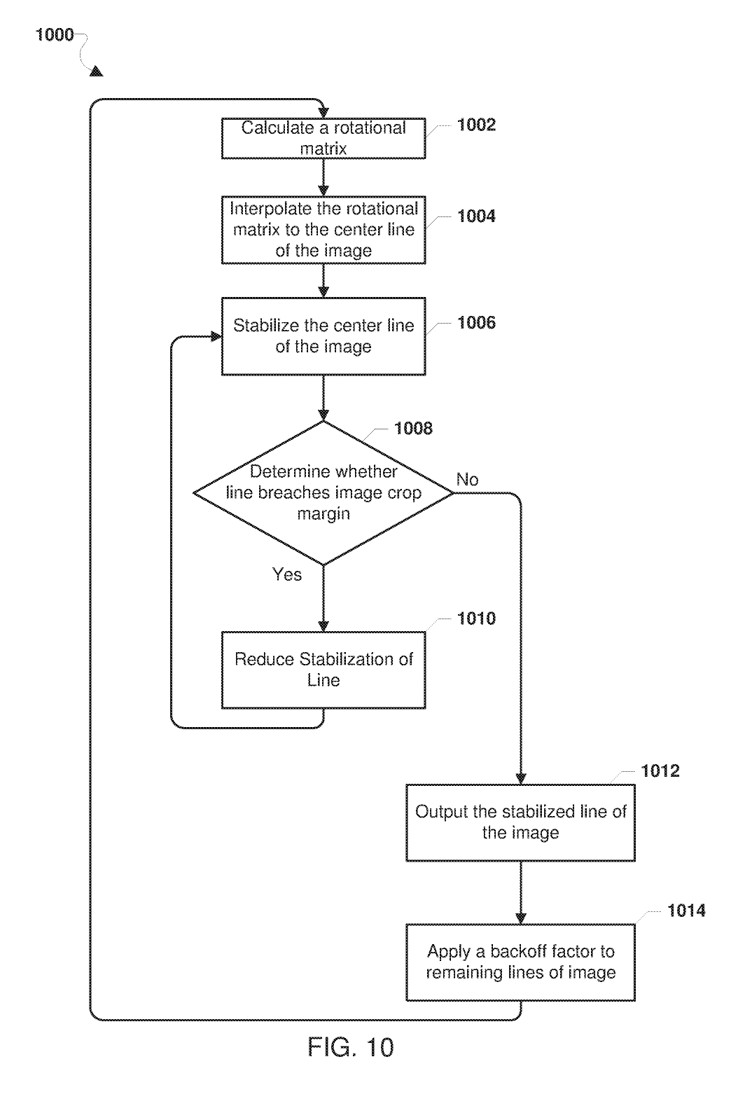

FIG. 10 illustrates a method 1000 of stabilizing an image captured in a UAV (e.g., 102, 200 in FIGS. 1 and 2) according to various embodiments. With reference to FIGS. 1-10, the method 1000 may be implemented by a processor (e.g., the processor 220 and/or the like) of the UAV.

In block 1002, the processor may calculate a rotation matrix defining the rotation of the image sensor of the UAV. This may be accomplished in the manner described with reference to block 802 of FIG. 8.

In block 1004, the processor may interpolate the rotation matrix to a center line of the image to obtain a center line rotation matrix. This may be accomplished in the manner described with reference to block 804 of FIG. 8. However, the processor may only execute the interpolation for the center line of the captured image rather than each line individually in an iterative basis.

In block 1006, the processor may stabilize the center line of the image based, at least in part, on the center line rotation matrix and a camera matrix. This may be accomplished in the manner described with reference to block 806 of FIG. 8.

In determination block 1008, the processor may determine whether stabilizing a line of the image causes a breach of an image crop margin, by determining whether the stabilized center line causes a breach of the image crop margin. This may be accomplished in the manner described with reference to block 704 of FIG. 7 and block 808 of FIG. 8.

In response to determining that stabilizing the line of the image causes a breach of the image crop margin (i.e., determination block 1008=“Yes”) the processor may, in block 1010 reduce stabilizing the line. This may be accomplished in the manner described with reference to block 706 of FIG. 7 as well as FIGS. 11 and 12.

In response to determining that stabilizing the line of the image does not cause a breach of the image crop margin (i.e., determination block 1008=“No”) the processor may, in block 1012 output the stabilized center line of the image.

In block 1014, the processor may apply a back off factor to each remaining line of the image. This may be accomplished in the manner described with reference to block 708 of FIG. 7. The processor may again calculate a rotational matrix in block 1002.

FIG. 11 illustrates a method 1100 of error correction in image stabilization of an image captured in a UAV (e.g., 102, 200 in FIGS. 1 and 2) according to various embodiments. With reference to FIGS. 1-11, the method 1100 may be implemented by a processor (e.g., the processor 220 and/or the like) of the UAV.

In block 1102, the processor may set a maximum rotation equal to the rotation matrix and a minimum rotation equal to the identity matrix. The rotation matrix may be calculated in any one of blocks 802 of FIG. 8, 902 of FIG. 9, or 1002 of FIG. 10. The identity matrix may be a 3×3 identity matrix. Thus, the maximum rotation may be that of the UAV/image sensor as a whole, while the minimum rotation may be no rotation at all.

In block 1104, the processor may interpolate the rotation matrix to halfway between the maximum rotation and the minimum rotation. The processor may use a step size of 0.5 (0.3, 0.25, etc.) and may calculate an interpolated rotation matrix half way (or a third or a quarter) of the way between the maximum rotation and the minimum rotation.

In determination block 1106, the processor may determine whether a maximum number of iterations has been reached. This may be accomplished by determining whether an iteration tracker, such as a parameter holding the value of the number of iterations executed or remaining for execution, has reached a pre-set number. In various embodiments, a pre-set number such as 5 or 10 may be used in order to constrain customization of the transformation matrix to useful intervals. For example, continuing to halve the rotation range until only percentages of a single degree remain, may not yield useful scope of rotation.

In response to determining that the maximum number of iterations has been reached (i.e., determination block 1106=“Yes”) the processor may, in block 1118 store the interpolated rotation matrix as a back off rotation matrix. The processor may keep the interpolated rotation matrix as a back off matrix to be used in calculating the transformation matrices of subframes of an image.

In response to determining that the maximum number of iterations has not been reached (i.e., determination block 1106=“No”) the processor may, in block 1108 increment an iteration tracker. In various embodiments, the iteration tracker may be increased or decreased to track the number of executed iterations or iterations remaining.

In determination block 1110, the processor may determine whether any line of the image causes a breach of the image crop margin. This may be accomplished in the manner described with reference to block 704 of FIG. 7.

In response to determining that no line of the image causes a breach of the image crop margin (i.e., determination block 1110=“No”) the processor may, in block 1112 set the maximum rotation to the maximum rotation of the previous iteration, and set the minimum rotation to the interpolated rotation matrix of the previous iteration.

In response to determining that any line of the image causes a breach of the image crop margin (i.e., determination block 1110=“Yes”) the processor may, in block 1114 set the minimum rotation to the minimum rotation of the previous iteration, and set the maximum rotation to the interpolated rotation matrix of the previous iteration.

The processor may return to block 1104 and repeat the operations described in blocks 1104-1114 until the maximum number of iterations is reached. Thus, with each iteration, a new rotation matrix is interpolated and margin breach is evaluated based on the application of the new rotation matrix to the subframe(s) of the image. The maximum and minimum are modified according to whether a breach has occurred, until all iterations are exhausted and a best fit rotation matrix is obtained.

FIG. 12 illustrates a method 1200 of error correction in image stabilization of an image captured in a UAV (e.g., 102, 200 in FIGS. 1 and 2) according to various embodiments. With reference to FIGS. 1-12, the method 1200 may be implemented by a processor (e.g., the processor 220 and/or the like) of the UAV.

In block 1202, the processor may set an interpolated rotation matrix equal to the rotation matrix. This may be accomplished in the manner described with reference to block 1102 of FIG. 11. However, only the interpolated rotation matrix is set to the general rotation matrix, rather than establishing a maximum and minimum rotation.

In block 1204, the processor may increment an iteration tracker. This may be accomplished in the manner described with reference to block 1108 of FIG. 11.

In block 1206, the processor may interpolate between the interpolated rotation matrix and the identity matrix by a back off factor value. The back off factor value may be a percentage indicating how much the interpolated rotation matrix should “back off” or shift in the direction of the identity matrix (e.g., no rotation). The closer the back off value is to 1, the more accurate the final interpolated rotation matrix may be. However, more iterations may be required of method 1200 than method 1100 because smaller changes in range of rotation are made with each pass.

In determination block 1208, the processor may determine whether a maximum number of iterations has been reached. This may be accomplished in the manner described with reference to block 1106 of FIG. 11.

In response to determining that the maximum number of iterations has been reached (i.e., determination block 1208=“Yes”) the processor may, in block 1214 store the interpolated rotation matrix as a back off rotation matrix. This may be accomplished in the manner described with reference to block 1118 of FIG. 11.

In response to determining that the maximum number of iterations has not been reached (i.e., determination block 1208=“No”) the processor may increment the iteration tracker in block 1210.

In determination block 1212, the processor may determine whether any line of the image causes a breach of the image crop margin. This may be accomplished in the manner described with reference to block 704 of FIG. 7.

In response to determining that no line of the image causes a breach of the image crop margin (i.e., determination block 1212=“No”) the processor may, in block 1214 store the interpolated rotation matrix as a back off rotation matrix. This may be accomplished in the manner described with reference to block 1118 of FIG. 11.

In response to determining that any line of the image causes a breach of the image crop margin (i.e., determination block 1212=“Yes”) the processor may return to block 1204 and increment an iteration tracker, and may interpolate between the interpolated rotation matrix of the previous iteration and the identity matrix by the back off factor value in block 1206.

Various embodiments enable the processor of the UAV to improve image capture and processing by the UAV. Various embodiments also improve the efficiency of image capture and processing by the UAV. Various embodiments further improve the accuracy of image stabilization and correction of distortions cause during image capture by the image sensor. Various embodiments enable improved image capture and processing by the UAV for a variety of body frame coordinate systems. Various embodiments further enable improved image capture and processing by the UAV for a variety of mounting orientations of the image sensor to the body frame of the UAV. Moreover, various embodiments further enable improved image capture and processing by the UAV for stabilizing and correcting image subject to rolling shutter distortion as well as blur from the roll, pitch, and yaw of a UAV image sensor.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 700, 800, 900, 1000, 1100, and 1200 may be substituted for or combined with one or more operations of the methods 700, 800, 900, 1000, 1100, and 1200, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A method of stabilizing an image in an unmanned autonomous vehicle (UAV), comprising:
capturing an image by a line-read image sensor of the UAV;
determining whether stabilizing a line of the image causes a breach of an image crop margin; and
reducing stabilizing of the line of the image in response to determining that stabilizing the line of the image causes a breach of the image crop margin.

2. The method of claim 1, further comprising:
calculating a rotation matrix defining a rotation of the image sensor of the UAV;
interpolating the rotation matrix to a line of the image to obtain a line rotation matrix;
stabilizing the line of the image based, at least in part, on the line rotation matrix and a camera matrix; and
outputting the stabilized line of the image in response to determining that stabilizing the line of the image does not cause a breach of the image crop margin.

3. The method of claim 2, wherein the line of the image is the first line read by the line-read image sensor, the method further comprising performing the operations of claims 1 and 2 for each line of the image until every line of the image is stabilized.

4. The method of claim 1, further comprising:
calculating a rotation matrix defining the rotation of the image sensor of the UAV; and
stabilizing the image based, at least in part, on the rotation matrix and a camera matrix;
wherein determining whether stabilizing the line of the image causes a breach of the image crop margin comprises:
determining whether any line of the stabilized image causes a breach of the image crop margin; and
in response to determining that stabilizing the line of the image does not cause a breach of the image crop margin:
interpolating the rotation matrix to each line of the image to obtain a line rotation matrix for each respective line;
stabilizing each line of the image based, at least in part, on the line rotation matrix for each respective line and a camera matrix; and
outputting each stabilized line of the image.

5. The method of claim 1, further comprising:
calculating a rotation matrix defining the rotation of the image sensor of the UAV;
interpolating the rotation matrix to a center line of the image to obtain a center line rotation matrix;
stabilizing the center line of the image based, at least in part, on the center line rotation matrix and a camera matrix; and
in response to determining that stabilizing the line of the image does not cause a breach of the image crop margin:
outputting the stabilized center line of the image; and
applying a back off factor to each remaining line of the image.

6. The method of claim 1, wherein reducing stabilizing of the line of the image comprises:
calculating a rotation matrix defining the rotation of the image sensor of the UAV;
setting a maximum rotation equal to the rotation matrix and a minimum rotation equal to the identity matrix;
interpolating the rotation matrix to halfway between the maximum rotation and the minimum rotation;
determining whether a maximum number of iterations has been reached; and
storing the interpolated rotation matrix as a back off rotation matrix in response to determining that the maximum number of iterations has been reached.

7. The method of claim 6, further comprising in response to determining that the maximum number of iterations has not been reached:
incrementing an iteration tracker;
determining whether any line of the image causes a breach of an image crop margin; and
in response to determining that no line of the image causes a breach of an image crop margin:
setting the maximum rotation to the maximum rotation of the previous iteration; and
setting the minimum rotation to the interpolated rotation matrix of the previous iteration.

8. The method of claim 6, further comprising in response to determining that the maximum number of iterations has not been reached:
incrementing an iteration tracker;,
determining whether any line of the image causes a breach of an image crop margin; and
in response to determining that any line of the image causes a breach of an image crop margin:
setting the minimum rotation to the minimum rotation of the previous iteration; and
setting the maximum rotation to the interpolated rotation matrix of the previous iteration.

9. The method of claim 1, wherein reducing stabilizing of the line of the image comprises:
calculating a rotation matrix defining the rotation of the image sensor of the UAV;
setting an interpolated rotation matrix equal to the rotation matrix;
incrementing an iteration tracker,
interpolating between the interpolated rotation matrix and the identity matrix by a back off factor value;
determining whether a maximum number of iterations has been reached; and
storing the interpolated rotation matrix as a back off rotation matrix in response to determining that the maximum number of iterations has been reached.

10. The method of claim 9, further comprising in response to determining that the maximum number of iterations has not been reached:
determining whether any line of the image causes a breach of an image crop margin; and
in response to determining that any line of the image causes a breach of an image crop margin:
incrementing an iteration tracker, and
interpolating between the interpolated rotation matrix of the previous iteration and the identity matrix by the back off factor value.

11. An unmanned autonomous vehicle (UAV), comprising a line-read image sensor and a processor coupled to the line-read image sensor and configured with processor-executable instructions to perform operations comprising:
capturing an image by a line-read image sensor of the UAV;
determining whether stabilizing a line of the image causes a breach of an image crop margin; and
reducing stabilizing of the line of the image in response to determining that stabilizing the line of the image causes a breach of the image crop margin.

12. An unmanned autonomous vehicle (UAV), comprising:
means for capturing an image by a line-read image sensor of the UAV;
means for determining whether stabilizing a line of the image causes a breach of an image crop margin; and
means for reducing stabilizing of the line of the image in response to determining that stabilizing the line of the image causes a breach of the imae crop margin.

13. A non-transitory processor-readable storage medium having stored thereon processor-executable instructions configured to cause a processor of an unmanned autonomous vehicle (UAV) to perform operations comprising:
capturing an image by a line-read image sensor of the UAV;
determining whether stabilizing a line of the image causes a breach of an image crop margin; and
reducing stabilizing of the line of the image in response to determining that stabilizing the line of the image causes a breach of the image crop margin.
